(19) United States
(12) Patent Application Publication
(10) Pub. No.: US 2006/0114403 A1
(43) Pub. Date: Jun. 1, 2006

(54) Display apparatus having multiple pixel layers

(75) Inventors: Ji-Young Kang, Daegu (KR); Seok-Kyu Yoon, Choongcheongnam-do (KR)

Correspondence Address: DLA PIPER RUDNICK GRAY CARY US, LLP, 2000 UNIVERSITY AVENUE, E. PALO ALTO, CA, 94303-2248, US

(73) Assignee: Samsung Electronics Co., Ltd.

(21) Appl. No.: 11/237,036

(22) Filed: Sep. 27, 2005

(30) Foreign Application Priority Data
Oct. 6, 2004 (KR) 10-2004-0079327

(51) Int. Cl. G02F 1/1343; G02F 1/1335

(52) U.S. Cl. 349/144; 349/106

(57) ABSTRACT

A display apparatus includes a display substrate including a display substrate, a first pixel layer and a second pixel layer. The display substrate includes a pixel region to display an image. The first pixel layer is formed on the pixel region, and has an opening that has a curved shape in plan view. The second pixel layer is formed in the opening, the second pixel layer having a shape that is similar to the curved shape of the opening. The second pixel layer is useful for repairing the pixel layer after removing sections to which undesirable foreign substances are attached. With the multi-pixel layer display device, malfunction rate is reduced and display quality is improved.

### CROSS-REFERENCE TO RELATED APPLICATION

This application relies for priority upon Korean Patent Application No. 2004-79327 filed on Oct. 6, 2004, the content of which is herein incorporated by reference in its entirety.

### BACKGROUND OF THE INVENTION

1. Field of the Invention

The present invention relates to a display apparatus, a method of manufacturing the display apparatus and an optical apparatus for manufacturing the display apparatus. More particularly, the present invention relates to a display apparatus capable of improving a display quality, a method of manufacturing the display apparatus and an optical apparatus for manufacturing the display apparatus.

2. Description of the Related Art

A display apparatus usually converts electric signals into an image. A liquid crystal display (LCD) apparatus, which is a popular type of display apparatus, displays an image by controlling light-transmittance through a liquid crystal layer. The light-transmittance is adjusted by varying an electric field that is applied to a liquid crystal layer in the liquid crystal display apparatus.

Typically, a liquid crystal display apparatus includes a liquid crystal layer that is disposed between two substrates. A pixel electrode is formed on one of the substrates, and a common electrode is formed on the other substrate in a way that an electric field can be formed between the pixel electrode and the common electrode when the apparatus is assembled.

The substrate including the common electrode also includes a color filter to display images in color. The color filter is disposed on the substrate such that it is positioned across the liquid crystal layer from each of the pixel electrodes when the liquid crystal display apparatus is assembled.

One of the problems encountered during the manufacture of liquid crystal display apparatus is that foreign substances such as contamination particles stick to the color filter. This is undesirable, as contaminants on the color filter significantly lower the display quality of the liquid crystal display apparatus. A method of removing the contaminant particles from the color filter is needed.

### SUMMARY OF THE INVENTION

The present invention obviates the above problems and provides a display apparatus with improved display quality by repairing the portion of the apparatus that is contaminated by foreign substances.

The present invention also provides a method of manufacturing the above display apparatus.

The present invention also provides an optical apparatus for manufacturing the above display apparatus.

In accordance with an aspect of the present invention, there is provided a display apparatus including a display substrate, a first pixel layer, and a second pixel layer. The display substrate includes a plurality of pixel regions to display an image. The first pixel layer is formed on the display substrate, and the first pixel layer includes an opening that has a curved shape. The second pixel layer is formed in the opening, and the second pixel layer has a shape that is substantially similar to the curved shape of the opening.

In accordance with another aspect of the present invention, there is provided a display apparatus including a display substrate, a first pixel layer, and a second pixel layer. The display substrate includes a plurality of pixel regions to display an image. The first pixel layer is formed on the display substrate and has a curved shape. The second pixel layer includes an opening that has a shape substantially similar to the first pixel layer.

In accordance with another aspect of the present invention, there is provided a method of manufacturing a display apparatus. The method includes forming a first pixel layer on a display substrate to display an image, forming an opening through the first layer and forming a second pixel layer that has substantially the same shape as the opening. The opening has a curved shape.

In accordance with another aspect of the present invention, there is provided an optical apparatus including a body, an opening forming unit and a laser beam generating unit. A display substrate is mounted on the body, and the display substrate includes a pixel layer. The opening forming unit includes at least two opening forming members that partially overlap each other to form an opening. The laser beam generating unit is disposed over the opening forming unit to generate a laser beam and irradiate a laser beam onto the pixel layer through the opening.

In accordance with the present invention, the display apparatus reduces malfunction generated in the process of repairing the pixel layer to remove foreign substances, and thereby improves display quality.

### BRIEF DESCRIPTION OF THE DRAWINGS

The above and other advantages of the present invention will become readily apparent by reference to the following detailed description when considered in conjunction with the accompanying drawings wherein:

FIG. 1 is a cross-sectional view illustrating a display apparatus in accordance with an exemplary embodiment of the present invention;

FIG. 2 is a cross-sectional view illustrating a first display substrate in FIG. 1;

FIG. 3 is a plan view illustrating a second display substrate in FIG. 1;

FIG. 4 is a cross-sectional view taken along a line 11-12 in FIG. 3;

FIG. 5 is a plan view illustrating a first display substrate manufactured using a manufacturing method of a display apparatus according to an exemplary embodiment of the present invention;

FIG. 6 is a cross-sectional view illustrating a black matrix BM formed on a second substrate using a manufacturing method of a display apparatus according to an exemplary embodiment of the present invention;

FIG. 7 is a cross-sectional view illustrating a color filter formed on the second substrate in FIG. 6;

FIG. 8 is a cross-sectional view illustrating a color filter from which a foreign substance in FIG. 7 is removed;

FIG. 9 is a cross-sectional view illustrating repairing of a color filter by dropping a color filter material into an opening of the color filter in FIG. 8;

FIG. 10 is a cross-sectional view illustrating dropping of a color filter material into an opening in FIG. 9;

FIG. 11 is a cross-sectional view illustrating a common electrode disposed on a second substrate to cover a color filter in FIG. 10;

FIG. 12 is a cross-sectional view illustrating an optical apparatus in accordance with an exemplary embodiment of the present invention;

FIG. 13 is a plan view illustrating an opening forming unit in FIG. 12; and

FIG. 14 is a plan view illustrating an optical apparatus in accordance with another exemplary embodiment of the present invention.

### DESCRIPTION OF THE EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Display Apparatus

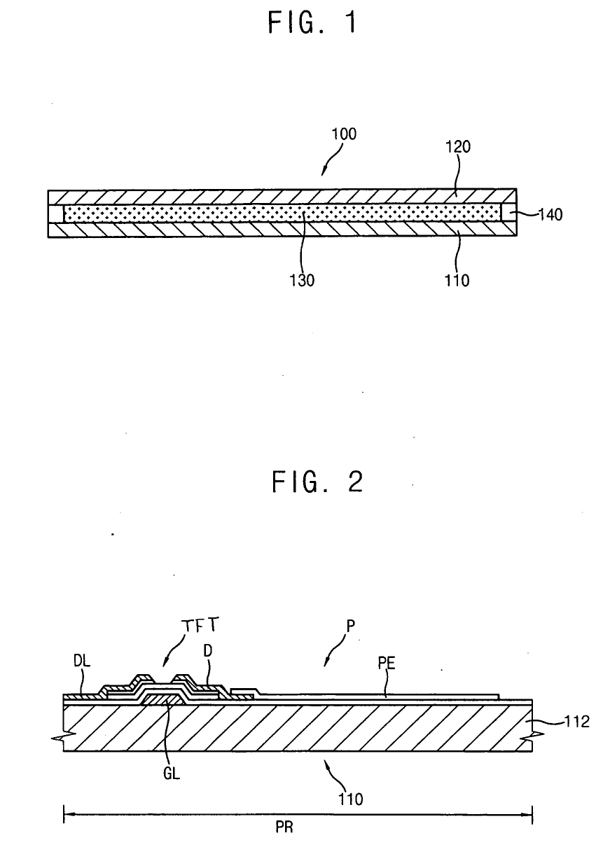

FIG. 1 is a cross-sectional view illustrating a display apparatus in accordance with an exemplary embodiment of the present invention.

Referring to FIG. 1, a display apparatus 100 includes a first display substrate 110, a second display substrate 120 and a liquid crystal layer 130 disposed between the first and second display substrates 110 and 120. The first display substrate 110 faces the second substrate 120. The first and second display substrates 110 and 120 are combined with each other through a sealant 140. The liquid crystal layer 130 is disposed in an area formed by the first and second display substrates 110 and 120 and the sealant 140.

FIG. 2 is a cross-sectional view illustrating a first display substrate in FIG. 1.

Referring to FIG. 2, the first display substrate 110 includes a first substrate 112 and a plurality of pixels formed on the first substrate 112. A pixel region PR is formed on the first substrate 112.

When a resolution of the display apparatus 100 is 1024×768, 1024×768×3 pixel regions are formed on the first display substrate 110, and the pixels ‘P’ are formed on the pixel regions PR in a substantially matrix shape.

Each of the pixels ‘P’ includes a thin film transistor TFT, a gate signal line GL, a data signal line DL, an output line ‘D’ and a pixel electrode PE.

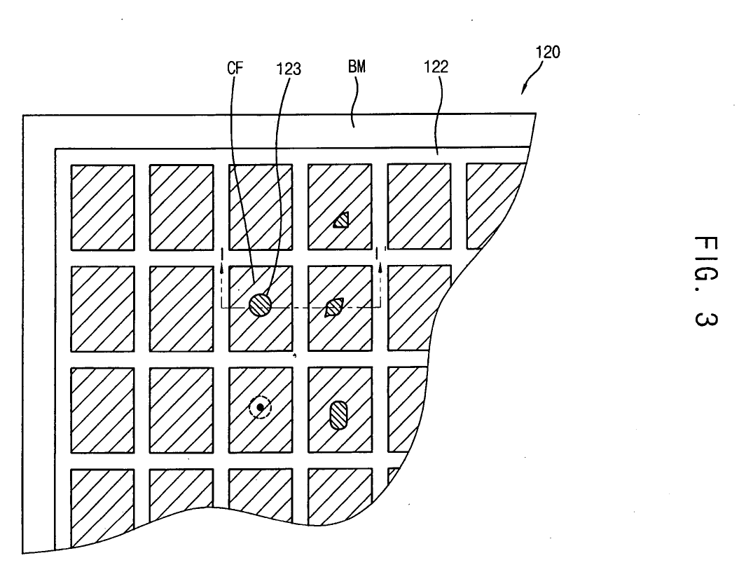

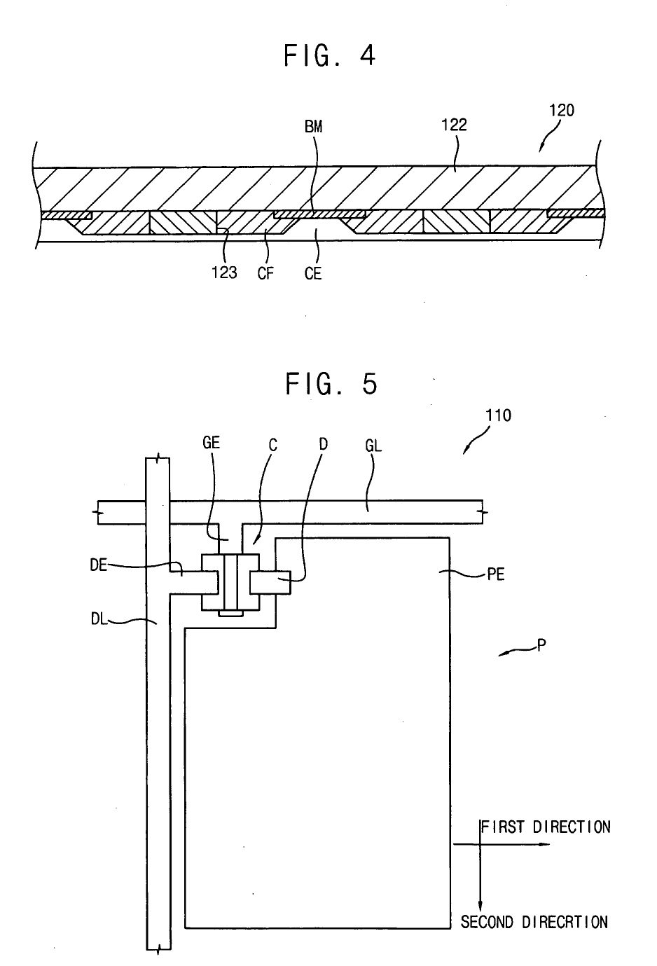

FIG. 3 is a plan view illustrating a second display substrate in FIG. 1. FIG. 4 is a cross-sectional view taken along a line I-I′ in FIG. 3.

Referring to FIGS. 3 and 4, the second display substrate 120 corresponds to the first display substrate 110. The second display substrate 120 includes a second substrate 122, a color filter CF, a black matrix BM and a common electrode CE.

The pixel regions are formed on the second display substrate 120 to display an image. The pixel regions formed on the second display substrate 120 corresponds to a pixel region PR formed on the first display substrate 110. When the display apparatus 100 has a resolution of about 1024×768, about 1024×768×3 pixel regions are formed on the second display substrate 120. A first pixel layer is formed in the pixel area PR to display an image.

The first pixel layer may include a color filter CF. The color filter CF includes a red color filter, a green color filter and a blue color filter. The red color filter filters light to transmit a red color, the green color filter filters light to transmit a green color, and the blue color filter filters light to transmit a blue color.

The black matrix BM is disposed between neighboring color filters CF to prevent light leakage near the border between the color filters CF. The black matrixes BM are arranged in a substantially matrix shape when viewed in plan view to prevent the light leakage between the color filter CF adjacent to each other.

The color filter CF as the first pixel layer formed on the second substrate 122 includes an opening 123. The opening 123 has a curved shape when viewed in plan view.

The opening 123 may have a substantially polygonal shape such as a quadrangular shape, a pentagonal shape, a hexagonal shape, etc. Also, at least one of the sides of the opening 123 may be curved, or all sides of the opening 123 may be curved.

In addition, the opening 123 may have a substantially circular shape or an oval shape in plan view.

A second pixel layer is formed in the opening 123 of the color filter CF as the first pixel layer. The second pixel layer includes a color filter.

The second pixel layer has substantially the same shape as a curved surface of the opening 123 in plan view, and at least one part of the second pixel layer makes contact with a curved surface of the opening 123. Preferably, the second pixel layer has substantially the same shape as the opening 123.

Therefore, when the opening 123 formed through the first pixel layer has a substantially circular shape in plan view, the second pixel layer has a circular shape substantially the same as the opening 123. When the opening 123 formed through the first pixel layer has a substantially polygonal shape having at least one curved surface in plan view, the second pixel layer has substantially the same shape and size as the opening 123.

When the color filter CF of the first pixel layer is a red color filter, the second pixel layer is a red color filter. When the color filter CF of the first pixel layer is a green color filter, the second pixel layer is a green color filter. When the color filter CF of the first pixel layer is a blue color filter, the second pixel layer is a blue color filter.

The first and second display substrates 110 and 120 are arranged such that there is a cell gap between them. The sealant 140 is disposed between the first and second display substrates 110 and 120 to fix their positions relative to each other and maintain the cell gap. The liquid crystal layer 130 is disposed in the cell gap formed between the first and second display substrates 110 and 120.

Method of Manufacturing a Display Apparatus

FIG. 5 is a plan view illustrating a first display substrate manufactured using a manufacturing method according to an exemplary embodiment of the present invention.

In order to manufacture a first display substrate 110, a gate line GL is formed on the first substrate 112. The gate line GL extends in a first direction, and a plurality of the gate lines GL are arranged substantially parallel to the first direction. When the display apparatus has a resolution of 1024×768, the gate lines include about 768 lines. A second direction is substantially perpendicular to the first direction. A gate electrode GE branches out from a gate line GL and extends in the second direction.

After gate lines GL are formed, an insulation layer (not shown) is formed on the first substrate 112 to cover the gate lines GL.

A channel layer ‘C’ is formed on the insulation layer under the gate electrode GE. The channel layer ‘C’ includes an amorphous silicon pattern and an n⁺ amorphous silicon pattern. The n⁺ amorphous silicon pattern is doped with a high concentration of ions. The n⁺ amorphous silicon pattern is spaced apart from an upper face of the amorphous silicon pattern.

A data line DL is formed on the insulation layer. The data lines DL extend in the second direction, and the data lines DL are arranged substantially parallel to the second direction. When the display apparatus has a resolution of about 1024×768, about 1024×3 data lines are formed on the insulation layer. A source electrode DE branches out from a data line DL and extends in the first direction.

The source electrode DE is electrically connected to one of two highly concentrated ion-doped amorphous silicon patterns.

A drain electrode ‘D’ is formed on the first substrate 112 from the same layer as the data line DL, preferably at the same time as the data line DL. The drain electrode ‘D’ is electrically connected to another of two highly concentrated ion-doped amorphous silicon patterns.

A pixel electrode PE is formed on an area defined by the gate line GL and the data line DL. The pixel electrode PE includes a transparent and conductive material such as indium tin oxide, indium zinc oxide, amorphous indium tin oxide, etc.

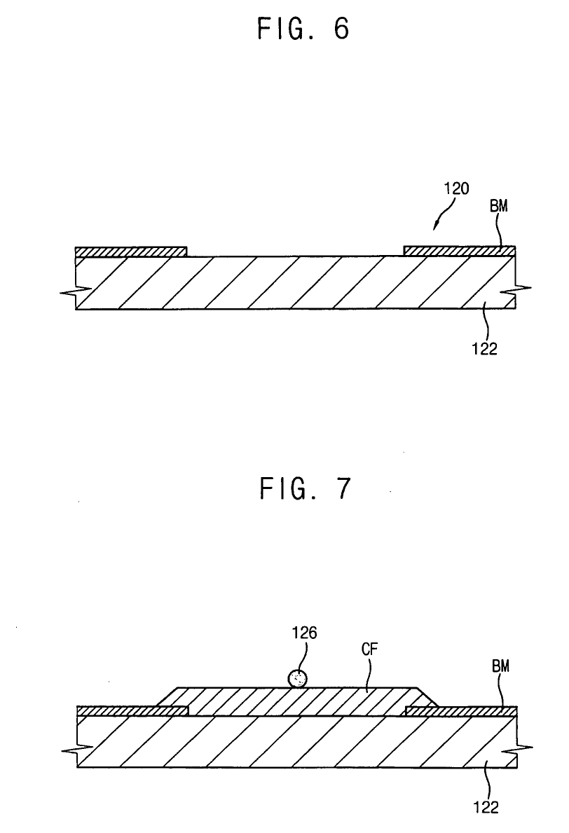

FIG. 6 is a cross-sectional view illustrating a black matrix BM formed on a second substrate using a manufacturing method according to an exemplary embodiment of the present invention.

Referring to FIG. 6, the black matrix BM is formed on the second display substrate 120. The black matrixes BM are formed on the second substrate 122, and arranged in a matrix shape. The black matrix BM includes an opaque metal material such as chrome, chrome oxide, etc. Alternatively, the black matrix BM may include an opaque organic material.

FIG. 7 is a cross-sectional view illustrating a color filter formed on the second substrate in FIG. 6.

Referring to FIG. 7, the color filter CF is formed on the second substrate 122. The color filter CF includes a red color filter, a green color filter and a blue color filter. The red color filter filters light to transmit a red color, the green color filter filters light to transmit a green color, and the blue color filter filters light to transmit a blue color.

Foreign substances such as particles 126 may stick to the color filter CF formed on the second substrate 122. The foreign substances may be detected using a visual inspection device (not shown). The foreign substances that stick to the color filter CF change the cell gap and the amount of light that passes through the color filter CF, significantly deteriorating display quality.

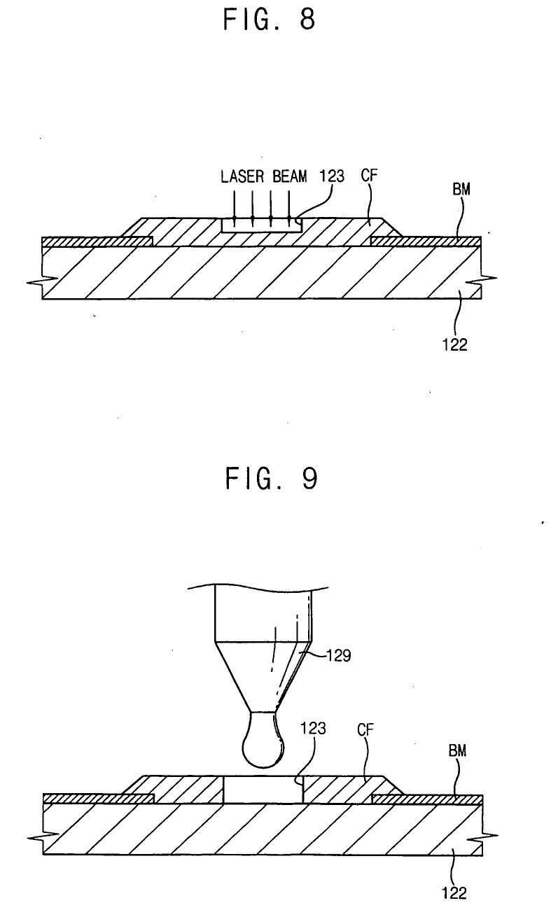

FIG. 8 is a cross-sectional view illustrating a color filter from which a foreign substance in FIG. 7 is removed.

Referring to FIG. 8, the portion of the color filter CF to which the foreign substance is attached is removed to form an opening 123 through the color filter CF. In order to form the opening 123 through the color filter CF, a laser beam having a wavelength of about 532 nm is used. The laser beam may have a wavelength of less than or greater than about 532 nm depending on the conditions. The laser beam includes a YAG laser beam.

The color filter CF that is irradiated by the laser beam may have a partially curved shape when viewed in a cross section that is substantially perpendicular to the irradiation direction of the laser beam. However, this is not a limitation of the invention and the color filter CF may have a different shape (e.g., a substantially circular shape or a partially curved polygonal shape) when viewed in the same cross section.

FIG. 9 is a cross-sectional view illustrating repairing of a color filter by dropping a color filter material into an opening of the color filter in FIG. 8.

Referring to FIG. 9, a dropping unit 129 is positioned over the opening 123 of the color filter CF to drop the color filter material into the opening 123. The dropping unit 129 is positioned above the opening 123.

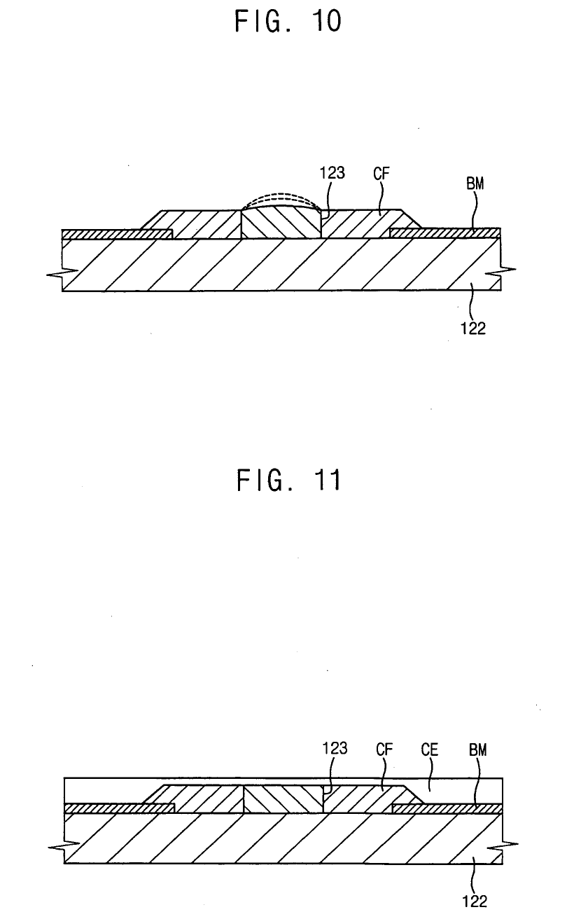

FIG. 10 is a cross-sectional view illustrating dropping the color filter material into an opening in FIG. 9.

Referring to FIG. 10, the color filter material is dropped into the opening 123 in the form of a droplet. The color filter material is in a liquid state. Initially, the volume of the dropped color filter material is measurably larger than the volume of the opening 123. Therefore, the surface of the color filter material is higher than the opening 123, as shown by the broken lines. However, when the color filter material is dried, the color filter material has a substantially same height as the opening 123.

A common electrode CE is formed on the second substrate 122 to cover the color filter CF. The common electrode CE includes transparent and conductive material such as indium tin oxide, indium zinc oxide, amorphous indium tin oxide, etc.

FIG. 11 is a cross-sectional view illustrating a common electrode disposed on a second substrate to cover a color filter in FIG. 10.

Referring to FIG. 11, the common electrode CE is formed on the color filter CF to cover the common electrode CE and the black matrix BM. The common electrode CE of the second display substrate 120 positioned so that it is across from the pixel electrode PE when the first substrate 112 and the second substrate 122 are assembled.

The sealant (not shown) is disposed between the first and second display substrates 110 and 120. The sealant, for example, is placed on the second display substrate 120. After placing the sealant, liquid crystals are provided to the second display substrate 120. Then, the sealant disposed between the first and second substrates 110 and 120 is cured by heat or ultraviolet light. The first display substrate 110 is combined with the second display substrate 120 to form the display apparatus.

Optical Apparatus

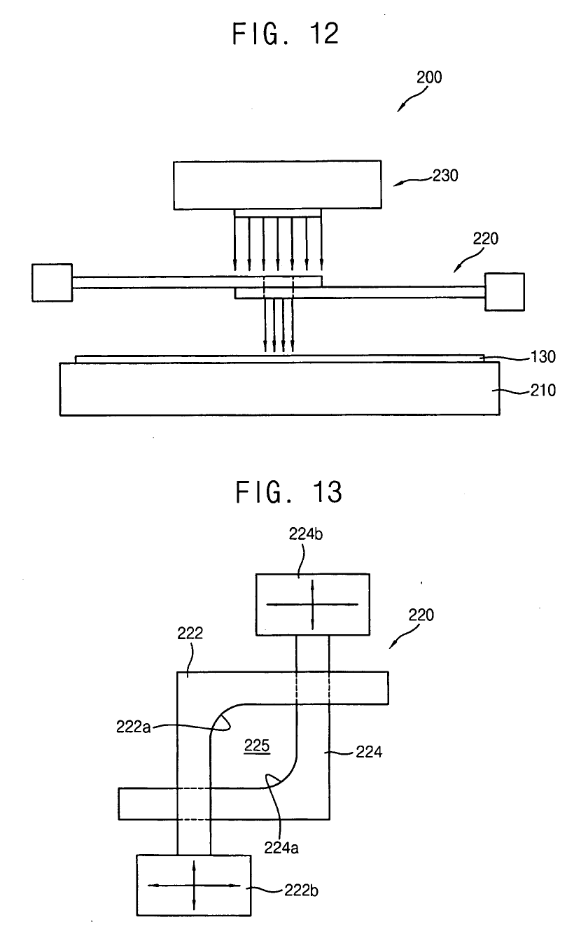

FIG. 12 is a cross-sectional view illustrating an optical apparatus in accordance with an exemplary embodiment of the present invention.

Referring to FIG. 12, an optical unit 200 includes a body 210, an opening forming unit 220 and a laser beam generating unit 230.

A display substrate 130 is mounted on the body 210. A color filter is formed on the display substrate 130.

The opening forming unit 220 is disposed over the body 210. The opening forming unit 220 provides an opening through which a laser beam passes. When a foreign substance sticks to the color filter, the laser beam passes through the opening to partially remove a color filter to which the foreign substance sticks.

The opening forming unit 220 includes a material that is highly durable to the laser beam. The opening forming unit 220 may be partially or completely curved when seen in plan view.

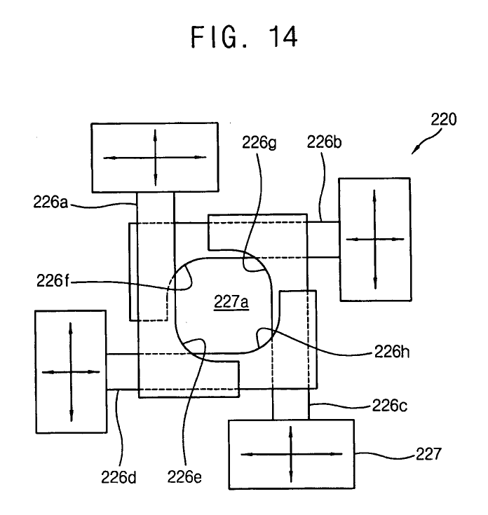

FIG. 13 is a plan view illustrating an opening forming unit in FIG. 12.

Referring to FIG. 13, the opening forming unit 220 includes first and second opening forming members 222 and 224 having a curved shape, or an L-shape. The first and second opening forming members have curved parts 222a and 224a, respectively, near the corners of the “L”s. The first and the second opening forming members 222 and 224 partially overlap each other so that the curved parts 222a and 224a are at diagonally opposite corners from each other.

The first and second opening forming members 222 and 224 may further include control units 222b and 224b, respectively, to control the first and second opening forming members 222 and 224 in order to adjust the size of an opening 225.

FIG. 14 is a plan view illustrating an optical apparatus in accordance with another exemplary embodiment of the present invention.

Referring to FIG. 14, an opening forming unit 220 includes a first opening forming member 226a, a second opening forming member 226b, a third opening forming member 226c and a fourth opening forming member 226d each having a curved shape, or an L-shape. The first opening forming member 226a, the second opening forming member 226b, the third opening forming member 226c and the fourth opening forming member 226d have curved parts 226e, 226f, 226g and 226h, respectively, near the corners of the “L”s. The first opening forming member 226a overlaps the second opening forming member 226b and the fourth opening forming member 226d, and the curved part 226e is at the diagonally opposite corner to the curved part 226g of the third opening forming member 226c.

The first opening forming member 226a, the second opening forming member 226b, the third opening forming member 226c and the fourth opening forming member 226d may each include a control unit 227 to control the first to fourth opening forming members 226a, 226b, 226c and 226d in order to adjust the size of an opening 227a.

A laser beam generating apparatus 230 generates a laser beam to irradiate the opening 227a. The laser beam generating apparatus 230 is disposed over the opening forming unit 220.

The laser beam generating unit 230 generates a YAG laser beam, and the YAG laser beam has a wavelength of about 532 nm.

The opening forming members 226a, 226b, 226c and 226d of the opening forming unit 220 have a curved shape, like an L-shape. In other embodiments, the opening forming members 226a, 226b, 226c and 226d may have variable shapes such as a U-shape, a C-shape, etc.

As described above, when foreign substances such as particles stick to a color filter, the color filter to which the foreign substances are stuck is partially removed to form an opening through the color filter. The color filter is then repaired by filling the opening with a color filter material. The opening has a partially curved part to reduce any malfunctions caused by the dropped color filter material that does not fully close the opening.

Although exemplary embodiments of the present invention have been described, it is understood that the present invention should not be limited to these exemplary embodiments but various changes and modifications can be made by one skilled in the art within the spirit and scope of the present invention as hereinafter claimed.

What is claimed is:

1. A display apparatus comprising:
a display substrate comprising a plurality of pixel regions to display an image;
a first pixel layer formed on the display substrate, the first pixel layer having an opening that has a curved shape; and
a second pixel layer formed in the opening, the second pixel layer having a shape that is substantially similar to the curved shape of the opening.

2. The display apparatus of claim 1, wherein the opening comprises a plurality of sides and at least one of the sides is curved.

3. The display apparatus of claim 1, wherein the curved shape is a substantially polygonal shape.

4. The display apparatus of claim 1, wherein the opening has a substantially circular shape.

5. The display apparatus of claim 1, wherein the first pixel layer comprises at least one color filter selected from the group consisting of a red color filter, a green color filter and a blue color filter.

6. The display apparatus of claim 1, wherein the second pixel layer comprises at least one color filter selected from the group consisting of a red color filter, a green color filter and a blue color filter.

7. The display apparatus of claim 1, wherein the second pixel layer comprises substantially the same material as the first pixel layer.

8. A display apparatus comprising:
a display substrate including a plurality of pixel regions to display an image;
a first pixel layer formed on the pixel area, the first pixel layer having a curved shape; and
a second pixel layer having an opening that corresponds to the first pixel layer.

9. The display apparatus of claim 8, wherein the first pixel layer has a substantially circular plate shape.

10. The display apparatus of claim 8, wherein the opening has a substantially circular shape similar to the shape of the first pixel layer.

11. A method of manufacturing a display apparatus comprising:
forming a first pixel layer on a pixel region formed on a display substrate to display an image;
forming an opening through the first pixel layer, the opening having a curved shape; and
forming a second pixel layer in the opening.

12. The method of claim 11, wherein the first pixel layer comprises at last one color filter selected from the group consisting of a red color filter, a green color filter and a blue color filter.

13. The method of claim 11, wherein the forming of the second pixel layer comprises dropping a material into the opening, wherein the material for forming the second pixel layer is substantially same as a material for forming the first pixel layer.

14. The method of claim 11, wherein the forming of the opening comprises irradiating a laser beam onto the first pixel layer.

15. The method of claim 14, wherein the laser beam comprises a YAG laser beam.

16. The method of claim 14, wherein the laser beam has a wavelength of about 532 nm.

17. An optical apparatus comprising:
a body on which a display substrate is mounted, the display substrate including a pixel layer;
an opening forming unit comprising at least two opening forming members that partially overlap each other to form an opening; and
a laser beam generating unit over the opening forming unit to generate a laser beam and irradiate the pixel layer through the opening.

18. The optical apparatus of claim 17, wherein the opening forming unit comprises first and second opening forming members having an L-shape.

19. The optical apparatus of claim 18, wherein each of the first and second opening forming members has a curved part, and the curved part of the first opening forming member is at a diagonally opposite corner from the curved part of the second opening forming member.

20. The optical apparatus of claim 17, wherein the opening forming unit comprises first, second, third and fourth opening forming members each having an L-shape, and each of the first, second, third and fourth opening forming members has a curved part.

21. The optical apparatus of claim 20, wherein the first opening forming member partially overlaps the second and fourth opening forming members, and the curved part of the first opening forming member and the curved part of the second opening forming member face the curved part of the third opening forming member and the curved part of the fourth opening forming member, respectively.

22. The optical apparatus of claim 17, wherein the laser beam comprises a YAG laser beam.

23. The optical apparatus of claim 17, wherein the opening forming unit further comprises controlling units that controls the opening forming unit to adjust a size of the opening.
